(19) United States
(12) Patent Application Publication
(10) Pub. No.: US 2014/0198023 A1
(43) Pub. Date: Jul. 17, 2014

(54) GATE DRIVER ON ARRAY AND METHOD FOR DRIVING GATE LINES OF DISPLAY PANEL

(71) Applicant: Novatek Microelectronics Corp., Hsinchu (TW)

(72) Inventor: Kuo-Hua Hsu, Taoyuan County (TW)

(21) Appl. No.: 13/929,806

(22) Filed: Jun. 28, 2013

(30) Foreign Application Priority Data
Jan. 14, 2013 (TW) 102101356

(51) Int. Cl. G09G 3/36

(52) U.S. Cl. CPC G09G 3/36
USPC 345/99

(57) ABSTRACT

A gate driver circuit including a plurality of gate driver stages is provided. The gate driver stages are combined on the display panel and configured to receive a plurality of clock signals and a start pulse. After being started by the start pulse, the gate driver stages generate a plurality of scan signals based on the clock signals. The scan signals respectively drive a plurality of gate lines of the display panel in a plurality of scan sequences during different frame periods based on the clock signals, wherein at least two scan sequences of the scan sequences are different. Furthermore, a method for driving gate lines of the display panel including the foregoing gate driver circuit is also provided.

### CROSS-REFERENCE TO RELATED APPLICATION

This application claims the priority benefit of Taiwan application serial no. 102101356, filed on Jan. 14, 2013. The entirety of the above-mentioned patent application is hereby incorporated by reference herein and made a part of this specification.

### BACKGROUND OF THE DISCLOSURE

1. Field of the Disclosure

The disclosure relates to a gate driver and a method for driving gate lines of a display panel including the gate driver.

2. Description of Related Art

A liquid crystal display (LCD) displays images under the control of a gate driver and a source driver. The gate driver can be categorized mainly into two types depending on the way it is designed, which are a gate driver on array (GOA) combined on the display panel, and a gate driver IC configured outside the display panel and manufactured with an externally connected silicon chip. With the GOA technique, the display panel does not need an externally connected gate driver IC. A timing control circuit is capable of generating a scan signal to drive the display panel by only transmitting a required clock signal and a voltage level to the gate driver of the display panel. FIG. 1 is diagram illustrating the signals for driving gate lines in a conventional gate driver.

Referring to FIG. 1, the gate driver controls a turning-on sequence of gate output channels by using a shift register. To be specific, after the gate driver starts the shift register by using a start pulse (STV), the gate output channels, denoted as GO[1], GO[2], GO[3], and GO[4], etc., sequentially turn on and turn off a gate line according to a clock signal (CLK). Thereafter, image data is input from the sources when pixels connected to these gate output channels are turned on by gate signals.

In order to reduce the fabrication cost of LCD, conventionally, a dual-gate structure is adopted as the pixel structure of LCD. Regarding the operation of the dual-gate structure, two adjacent odd and even pixels are respectively driven by the same source output during the time of a horizontal line, so that the number of sources can be reduced by half but the number of gates has to be doubled. The fabrication cost of a conventional LCD in which the number of sources is greater than the number of gates can be reduced by adopting such a dual-gate structure.

However, conventionally, the clock signals transmitted to the gate driver combined on the display panel are fixed during each frame period, and can only generate the scan signals in sequence as shown in FIG. 1, which are lack of flexibility. The same circuit layout cannot be employed to generate scan signals in different scan sequences, and the mura defect emerged in certain special pixel layouts cannot be solved accordingly.

### SUMMARY OF THE DISCLOSURE

The disclosure provides a gate driver circuit combined on a display panel, which is capable of providing two or more types of scan signals that are not arranged in sequence.

The disclosure provides a method for driving a gate line of a display panel, which is capable of providing two or more types of scan signals that are not arranged in sequence to drive the display panel.

The disclosure provides a gate driver circuit, including a plurality of gate driver stages. The gate driver stages are combined on the display panel and configured for receiving a plurality of clock signals and a start pulse. After being started by the start pulse, the gate driver stages generate a plurality of scan signals based on the clock signals. The scan signals respectively drive a plurality of gate lines of the display panel in a plurality of scan sequences during different frame periods based on the clock signals. At least two scan sequences among the scan sequences are different.

In an embodiment of the disclosure, the scan signals drive a gate line of a display panel in at least a first scan sequence and a second scan sequence during the different frame periods. The first scan sequence and the second scan sequence are different.

In an embodiment of the disclosure, based on the first scan sequence, a driving mode of the scan signals is one selected from a Z driving mode, an invert-Z driving mode, a first C/invert-C mixed driving mode, and a second C/invert-C mixed driving mode.

In an embodiment of the disclosure, based on the second scan sequence, a driving mode of the scan signals is one selected from the Z driving mode, the invert-Z driving mode, the first C/invert-C mixed driving mode, and the second C/invert-C mixed driving mode and is different from the driving mode to which the first scan sequence corresponds.

In an embodiment of the disclosure, the scan signals drive the gate lines of the display panel in at least the first scan sequence, the second scan sequence, and a third scan sequence during the different frame periods. At least two scan sequences of the first scan sequence, the second scan sequence, and the third scan sequence are different.

In an embodiment of the disclosure, based on the first scan sequence, a driving mode of the scan signals is one selected from the Z driving mode, a y driving mode, and an invert-y driving mode.

In an embodiment of the disclosure, based on the second scan sequence, a driving mode of the scan signals is one selected from the Z driving mode, the y driving mode, and the invert-y driving mode and is different from the driving mode to which the first scan sequence corresponds.

In an embodiment of the disclosure, based on the third scan sequence, a driving mode of the scan signals is one selected from the Z driving mode, the y driving mode, and the invert-y driving mode and is different from a driving mode to which the first scan sequence and the second scan sequence correspond.

In an embodiment of the disclosure, the gate driver stages are categorized into a plurality of gate driver groups. Each gate driver group includes a first gate driver stage and a plurality of second gate driver stages. After being started by the start pulse, the first gate driver stage generates a corresponding one of the scan signals based on one of the clock signals. Each of the second gate driver stages generates a corresponding one of the scan signals based on the clock signals and the output of the gate driver stage prior to the each of the second gate driver stages.

In an embodiment of the disclosure, the gate driver stages are categorized into X of gate driver groups. The clock signals include Y of clock signals. Y=2X, X≧2, and X and Y are natural numbers.

The disclosure provides a method for driving a gate line of a display panel, including steps of receiving a plurality of clock signals and a start pulse by a plurality of gate driver stages, wherein the gate driver stages are combined on the display panel; generating a plurality of scan signals based on the clock signals and the start pulse by the gate driver stages, wherein the scan signals have a plurality of scan sequences during different frame periods; and respectively driving a plurality of gate lines of the display panel by the scan signals during different frame periods by the gate driver stages. At least two scan sequences among the scan sequences are different.

In an embodiment of the disclosure, in the step of respectively driving the gate lines of the display panel by the scan signals during the different frame periods, the gate lines of the display panel are driven in at least a first scan sequence, a second scan sequence. The first scan sequence the second scan sequence are different.

In an embodiment of the disclosure, in the step of respectively driving the gate lines of the display panel by the scan signals during the different frame periods, the gate lines of the display panel are driven in at least the first scan sequence, the second scan sequence, and a third scan sequence. At least two scan sequences among the first scan sequence, the second scan sequence, and the third scan sequence are different.

Based on the aforementioned, in exemplary embodiments of the disclosure, the layout of the gate driver circuit is the same, and two or more types of scan signals that are not arranged in sequence are generated by receiving clock signals at different timing.

In order to make the aforementioned features and advantages of the disclosure more comprehensible, embodiments accompanying figures are described in detail below.

### BRIEF DESCRIPTION OF THE DRAWINGS

FIG. 1 is diagram illustrating the signals for driving gate lines in a conventional gate driver.

FIG. 2 is diagram illustrating an image display in an embodiment of the disclosure.

FIGS. 3A-3D are diagrams illustrating different charging sequences for pixel structures of a dual-gate display panel in FIG. 2.

FIG. 4 is diagram illustrating an internal circuit layout of a gate driver circuit in an embodiment of the disclosure.

FIGS. 5A and 6A are signal waveform diagrams respectively illustrating each signal of a gate driver circuit in FIG. 4 during two consecutive frame periods.

FIGS. 5B and 6B are diagrams respectively illustrating charging sequences for a portion of pixels of the display panel during two consecutive frame periods.

FIG. 7 is diagram illustrating an internal circuit layout of a gate driver circuit in another embodiment of the disclosure.

FIGS. 8 and 9 are signal waveform diagrams respectively illustrating each signal of a gate driver circuit in FIG. 7 during two consecutive gate output sequences.

FIG. 10 is diagram illustrating a second C/invert-C mixed driving mode of a scan signal.

FIG. 11 is diagram illustrating an internal circuit layout of a gate driver circuit in another embodiment of the disclosure.

FIG. 12 is diagram illustrating an internal circuit layout of a gate driver circuit in another embodiment of the disclosure.

FIGS. 13, 14A, and 15A are signal waveform diagrams respectively illustrating each signal of a gate driver circuit during three consecutive gate output sequences.

FIGS. 14B and 15B are diagrams respectively illustrating charging sequences for a portion of pixels of a display panel during a second and a third gate output sequences.

FIG. 16 is a flowchart illustrating steps in a method for driving gate lines in an embodiment of the disclosure.

### DESCRIPTION OF EMBODIMENTS

Below, embodiments of the disclosure will be described. However, these embodiments are not intended to limit the scope of the disclosure, and these embodiments can be appropriately combined.

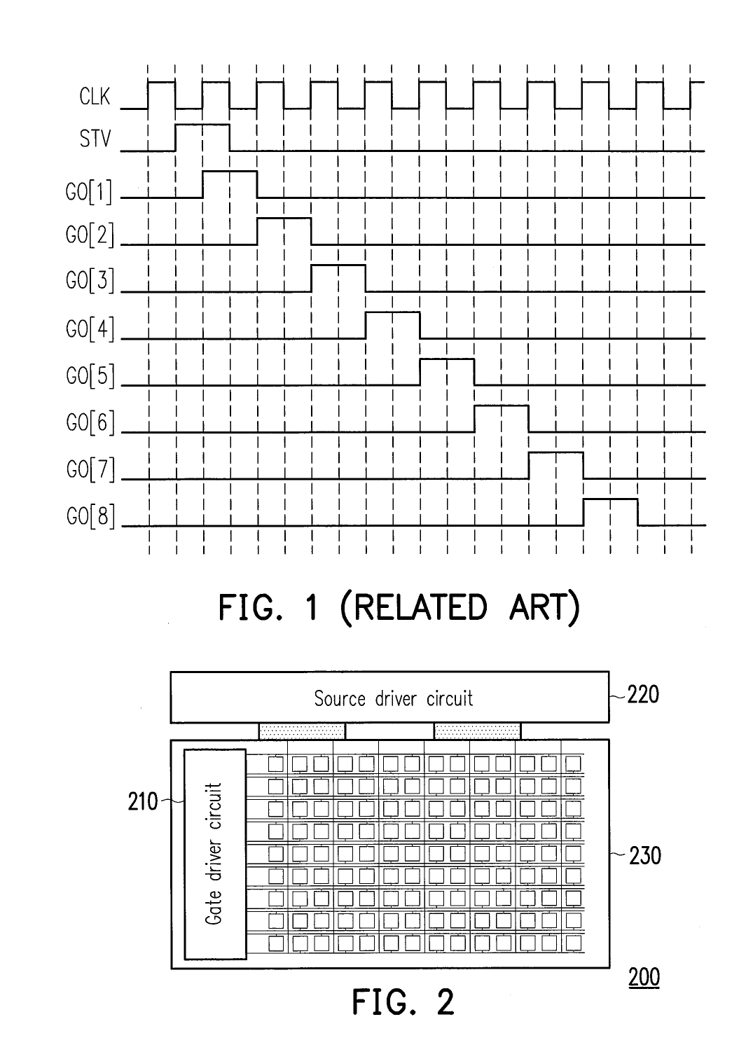

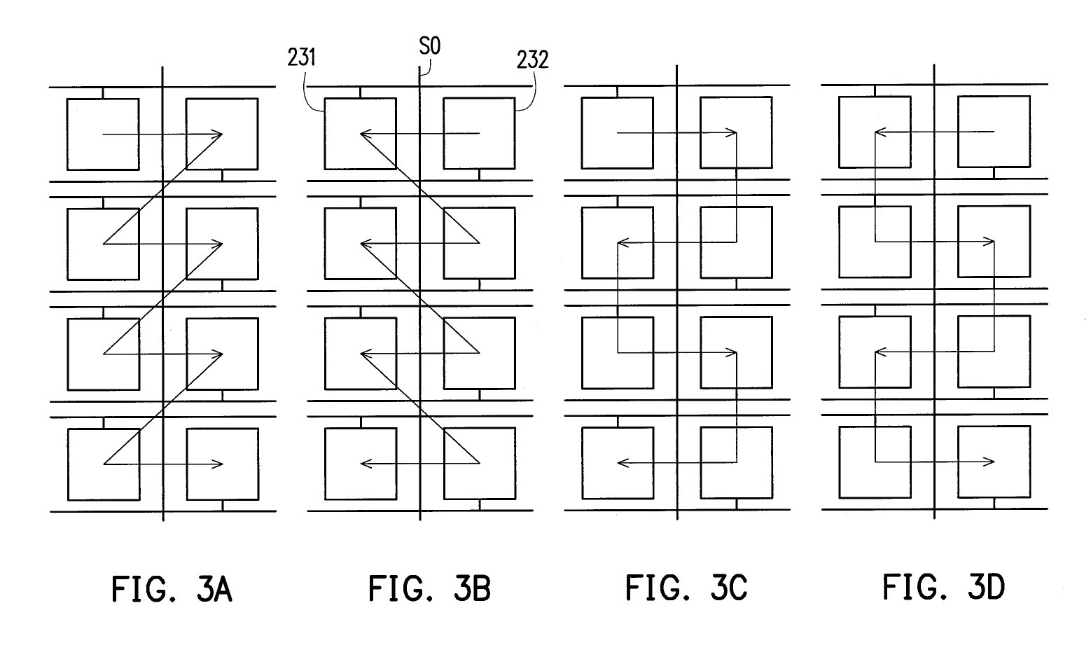

FIG. 2 is diagram illustrating an image display in an embodiment of the disclosure. FIGS. 3A-3D are diagrams illustrating different charging sequences for pixel structures of a dual-gate display panel in FIG. 2. Referring to FIGS. 2-3D, an image display 200 in the exemplary embodiment includes a gate driver circuit 210, a source driver circuit 220, and a dual-gate display panel 230. The gate driver circuit 210 is combined on the dual-gate display panel 230. Two adjacent odd and even pixels 231 and 232 on the dual-gate display panel 230 are connected to the same source output SO to form a dual-gate pixel structure. Therefore, regarding the operation of the image display 200, the two adjacent odd and even pixels 231 and 232 are driven respectively during the time of a horizontal line by the same source output SO to obtain different charging sequences. FIGS. 3A-3D are diagrams illustrating different charging sequences for pixel structures of the dual-gate display panel 230, wherein the sequences from left to right are Z charging sequence, invert-Z charging sequence, C/invert-C charging sequence, and invert-C/C charging sequence. In the exemplary embodiment, the gate driver circuit 210 uses scan signals with different driving modes to drive the display panel 230, and the pixel structures thereof is capable of performing charging in a corresponding charging sequence. The technical feature is described in detail in the following different exemplary embodiments provided below.

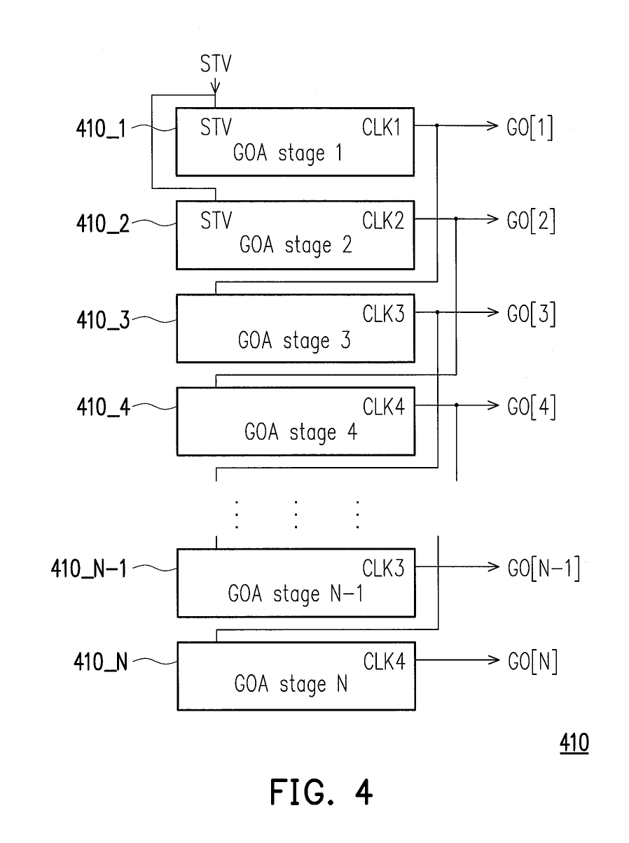

FIG. 4 is diagram illustrating an internal circuit layout of a gate driver circuit in an embodiment of the disclosure. Referring to FIG. 4, a gate driver circuit 410 in the exemplary embodiment includes a plurality of gate driver stages 410_1 to 410_N. The gate driver stages 410_1 to 410_N are combined on a display panel for receiving a plurality of clock signals CLK1 to CLK4 and a start pulse STV. After being started by the start pulse STV, the gate driver stages 410_1 to 410_N generate a plurality of scan signals GO[1] to GO[N] according to the received clock signals CLK1 to CLK4. In the embodiment, each gate driver stage includes, for example, a shift register to execute the operation of generating the scan signals GO[1] to GO[N].

Specifically, the gate driver stages 410_1 to 410_N in the exemplary embodiment can be roughly categorized into two gate driver groups. Each gate driver group includes a first gate driver stage and a plurality of second gate driver stages. In the embodiment, the first gate driver group includes a first gate driver stage 410_1 and second gate driver stages 410_3, . . . , and 410_N−1. The second gate driver group includes a first gate driver stage 410_2 and second gate driver stages 410_4, . . . , and 410_N. At this time, N is an even number. In the first gate driver group, the first gate driver stage 410_1 receives the start pulse STV, and the clock signal CLK1 delays the start pulse STV to generate a corresponding scan signal GO[1]. In addition, in the first gate driver group, the second gate driver stages 410_3, . . . , and 410_N−1 generate scan signals GO[2] to GO[N] based on the clock signals CLK1 to CLK4 and the output of the gate driver stage prior to the second gate driver stages. For example, the gate driver stage 410_3 delays the scan signal GO[1] generated by the gate driver stage 410_1 based on the clock signal CLK3 so as to generate the scan signal GO[3]. Likewise, the signals of other gate driver stages in the first gate driver group are generated in the same manner as described above, and therefore no further description is incorporated herein.

Similarly, in the second gate driver group, the gate driver stage 410_2 receives the start pulse STV and delays the start pulse STV based on the clock signal CLK2 so as to generate a corresponding scan signal GO[2]. Additionally, in the second gate driver group, the gate driver stage 410_4 delays the scan signal GO[2] generated by the gate driver stage 410_2 according to the clock signal CLK4 so as to generate the scan signal GO[4]. Likewise, the signals of other gate driver stages in the second gate driver group are generated in the same manner as described above, and therefore no further description is incorporated herein.

In summary, in the exemplary embodiment, each gate driver group includes a first gate driver stage and a plurality of second gate driver stages. After being started by a start pulse STV, the first gate driver stage generates one of corresponding scan signals (such as a scan signal GO[1]) based on one of the clock signals (such as a clock signal CLK1). The second gate driver stages generate a plurality of corresponding scan signals GO[2] to GO[N] of the scan signals based on the clock signals CLK1 to CLK4 and the output of the gate driver stage prior to the second gate driver stages. Meanwhile, in the exemplary embodiment, the scan signals GO[1] to GO[N] respectively drive a plurality of gate lines of the display panel in a plurality of different scan sequences during different frame periods.

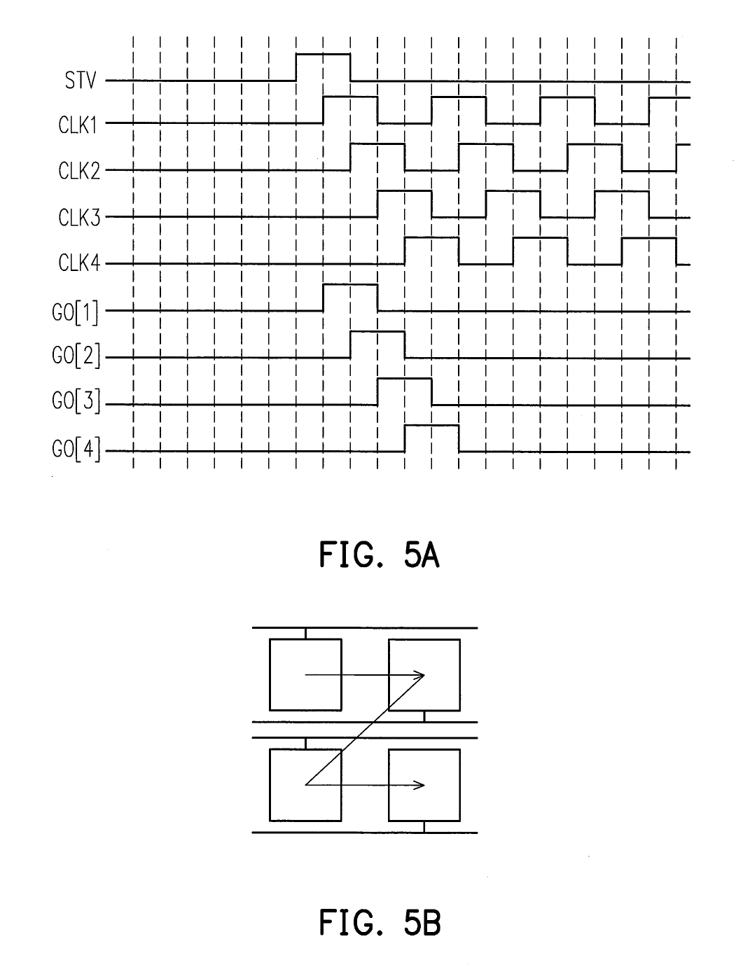

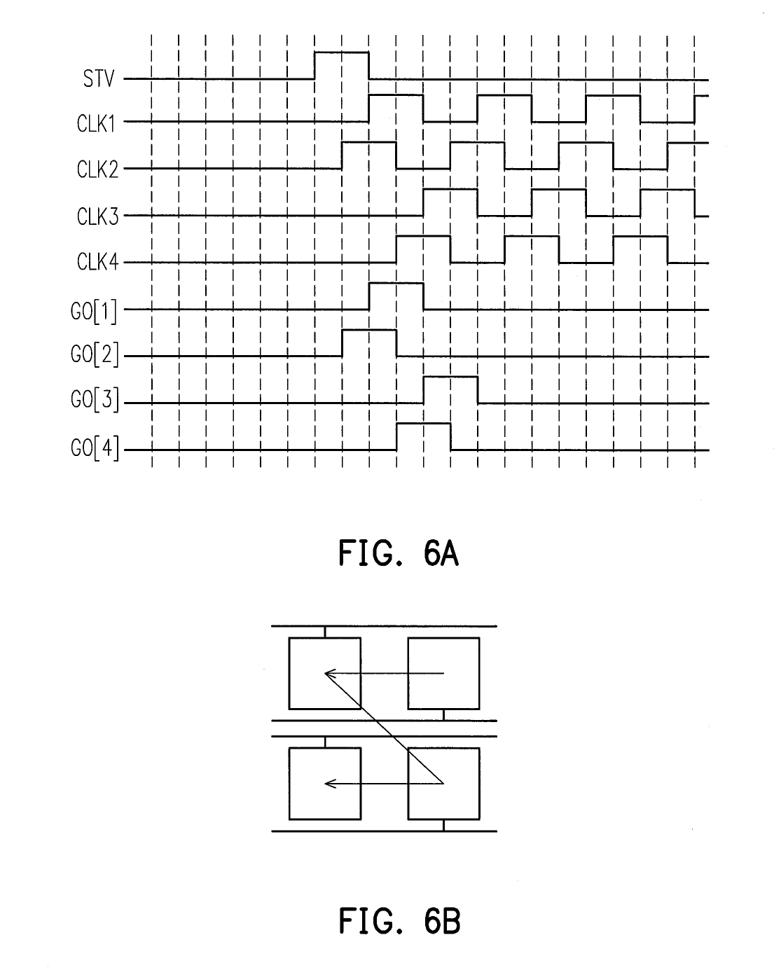

To be specific, FIGS. 5A and 6A are signal waveform diagrams respectively illustrating each signal of a gate driver circuit in FIG. 4 during two consecutive frame periods. FIGS. 5B and 6B are diagrams respectively illustrating charging sequences for a portion of pixels of a display panel during two consecutive frame periods. In order to keep the description brief, in FIGS. 5A and 6A, only the signal waveform diagrams of four gate driver stages 410_1 to 410_4 are illustrated as examples; however, the number of the signal waveform diagrams provides no limitation to the scope of the disclosure.

Referring to FIG. 5A, FIG. 5A defines a Z driving mode of scan signals GO[1] to GO[4], wherein the gate lines are turned on in a first scan sequence: GO[1]→GO[2]→GO[3]→GO[4]. During the n^{th} frame period, the gate driver stages 410_1 to 410_4 accomplish a Z pixel charging sequence as shown in FIG. 5B based on the start pulse STV and the clock signals CLK1 to CLK4, thereby accomplishing a space-averaged effect. The quality of the display image can be improved through time- or space-averaging.

Referring to FIGS. 6A and 6B, based on the same mechanism and effect, the sequence of turning on the gate lines during the n+1^{th} frame period may also be changed to an invert-Z driving mode. In this case, the scan signals GO[1] to GO[4] turn on the gate lines in a second scan sequence: GO[2]→GO[1]→GO[4]→GO[3]. Based on the second scan sequence, the gate driver stages 410_1 to 410_4 are capable of driving panel pixels to accomplish the invert-Z pixel charging sequence as shown in FIG. 6B.

From another perspective, comparing the clock signals CLK1 to CLK4 in FIGS. 5A and 6A, and they may be categorized into two sets of clock signals. For example, the clock signals CLK1 and CLK2 may be in a set, and the clock signals CLK3 and CLK4 may be in another set. During the n^{th} frame period, the clock signals CLK1 to CLK4 are sequentially transmitted to the gate driver stages 410_1 to 410_4. During the n+1^{th} frame period, in comparison with the n^{th} frame period, the sequences in which the clock signals CLK1 and CLK2 are transmitted to the gate driver stage are switched; the sequences in which the clock signals CLK3 and CLK4 are transmitted to the gate driver stage are also switched. Therefore, the scan signals GO[1] to GO[4] generated during different frame periods have the same sequence feature in corresponding to the clock signals CLK1 to CLK4.

In the exemplary embodiment, during the n+2^{th} frame period and the subsequent frame periods, the gate driver stages 410_1 to 410_N may drive the gate lines of the display panel in the first scan sequence or the second scan sequence; the disclosure is not limited thereto. That is to say, the scan signals 410_1 to 410_N in the exemplary embodiment respectively drive the plurality of gate lines of the display panel in a plurality of scan sequences during different frame periods, wherein at least two scan sequences among the scan sequences are different. Therefore, in the exemplary embodiment, the gate driver circuit 410 uses the scan signals GO[1] to GO[N] with different driving modes to drive the display panel, and the pixel structure thereof is capable of performing charging in a corresponding charging sequence.

Additionally, in the exemplary embodiment, the gate driver stages are categorized into two gate driver groups, which are capable of generating a plurality of scan signals 410_1 to 410_N with different scan sequences based on the four clock signals CLK1 to CLK4.

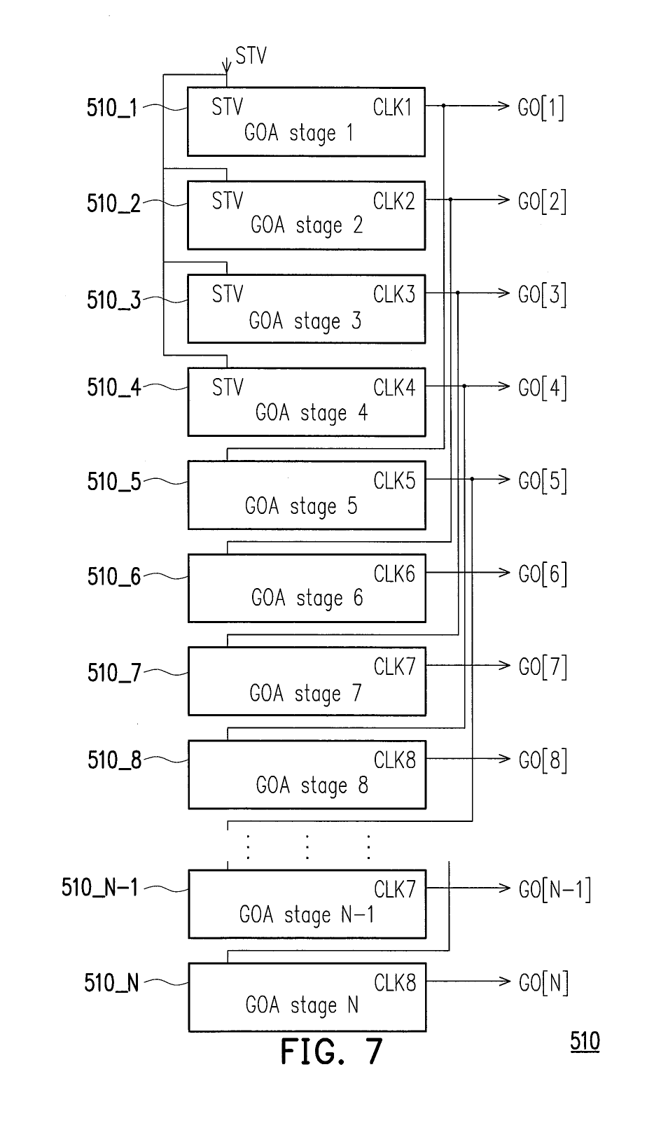

FIG. 7 is diagram illustrating an internal circuit layout of a gate driver circuit in another embodiment of the disclosure. Referring to FIGS. 4 and 7, a gate driver circuit 510 in the exemplary embodiment is similar to the gate driver circuit 410 in FIG. 4, the main difference between them lies in that, for example, gate driver stages 510_1 to 510_N in the exemplary embodiment are categorized into four gate driver groups. A first gate driver group includes gate driver stages 510_1, 510_5, . . . , and 510_N−3 (not shown). A second gate driver group includes gate driver stages 510_2, 510_6, . . . , and 510_N−2 (not shown). A third gate driver group includes gate driver stages 510_3, 510_7, . . . , and 510_N−1. A fourth gate driver group includes gate driver stages 510_4, 510_8, . . . , and 510_N. At this time, N is a multiple of 4 and is greater than 8.

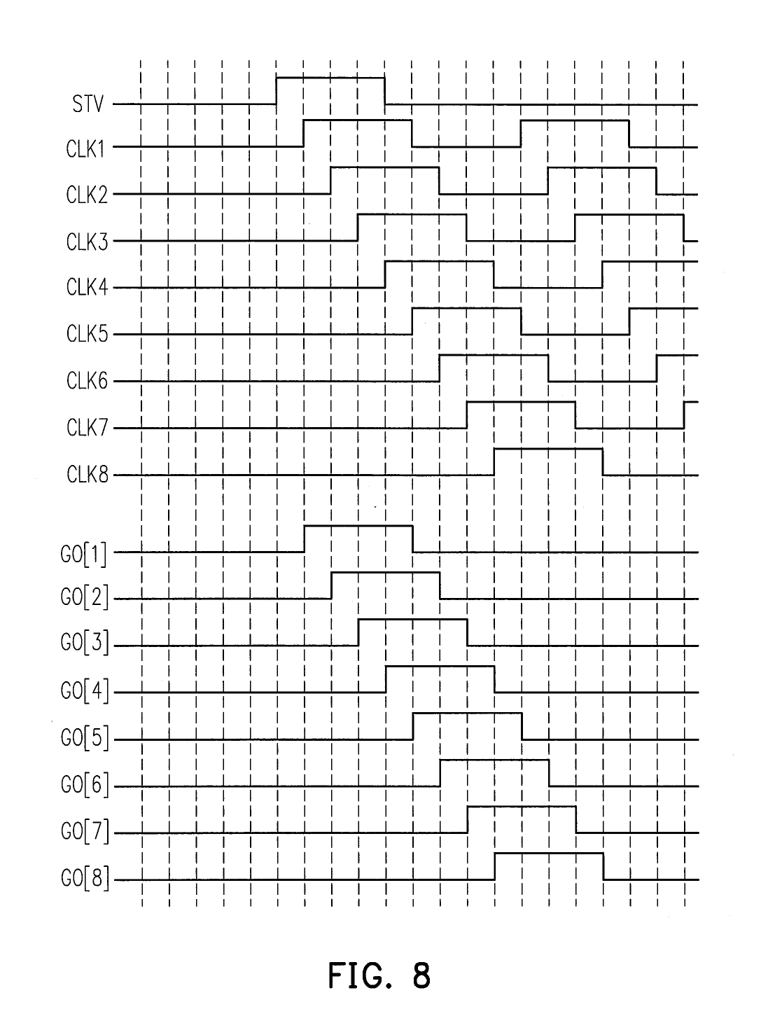

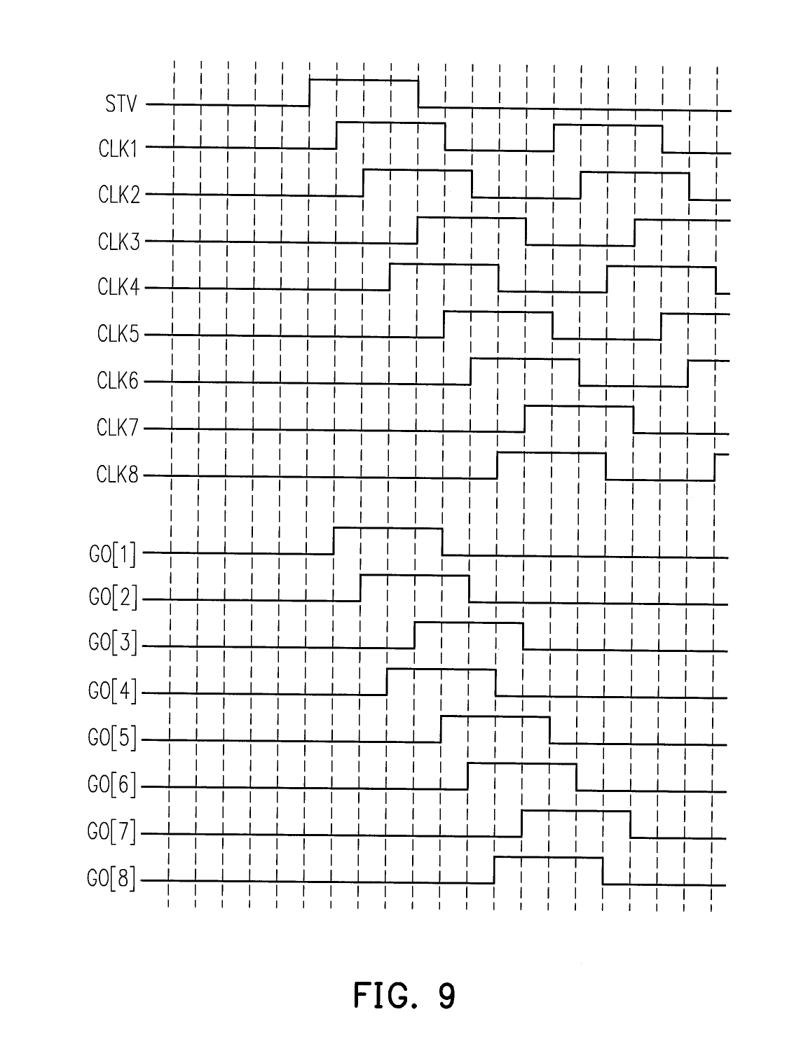

FIGS. 8 and 9 are signal waveform diagrams respectively illustrating each signal of the gate driver circuit in FIG. 7 during two consecutive gate output sequences. In order to keep the description brief, in FIGS. 8 and 9, only the signal waveform diagrams of eight gate driver stages 510_1 to 510_8 are provided as examples; however, the number of the signal waveform diagrams provides no limitation to the scope of the disclosure.

Referring to FIG. 8, the gate driver stages 510_1 to 510_8 receive clock signals CLK1 to CLK8 that are in sequence during a first gate output sequence. Accordingly, based on the clock signals, the gate driver stages 510_1 to 510_8 also generate scan signals GO[1] to GO[8] that are in sequence to drive the display panel, and a charging sequence for the pixels of the display panel is a Z pixel charging sequence as shown in FIG. 3A. Therefore, during the first gate output sequence, the scan signals GO[1] to GO[8] turn on the gate lines in a first scan sequence: GO[1]→GO[2]→GO[3]→GO[4]→GO[5]→GO[6]→GO[7]→GO[8].

Next, during a second gate output sequence, referring to FIG. 9, FIG. 9 defines a first C/invert-C mixed driving mode of the scan signals GO[1] to GO[8], i.e. an invert-C and C mixed mode; the scan signals turn on the gate lines in a second scan sequence: GO[1]→GO[2]→GO[4]→GO[3]→GO[5]→GO[6]→GO[8]→GO[7]. During the second gate output sequence, the gate driver stages 510_1 to 510_8 accomplish a first C/invert-C mixed pixel charging sequence as shown in FIG. 3C based on the start pulse STV and the clock signals CLK1 to CLK8. From another perspective, comparing the clock signals CLK1 to CLK8 in FIGS. 8 and 9, during the first gate output sequence, the clock signals CLK1 to CLK8 are sequentially transmitted to the gate driver stages 510_1 to 510_8. During the second gate output sequence, in comparison with the first gate output sequence, sequences in which the clock signals CLK3 and CLK4 are transmitted to the gate driver stage are switched; sequences in which the clock signals CLK7 and CLK8 are transmitted to the gate driver stage are also switched. Therefore, the scan signals GO[1] to GO[8] generated during different gate output sequences also have the same sequence feature in corresponding to the clock signals CLK1 to CLK8.

Thereafter, during the third and subsequent gate output sequences, the gate driver stages 510_1 to 510_N may drive the gate lines of the display panel in the first scan sequence or the second scan sequence; the disclosure is not limited thereto.

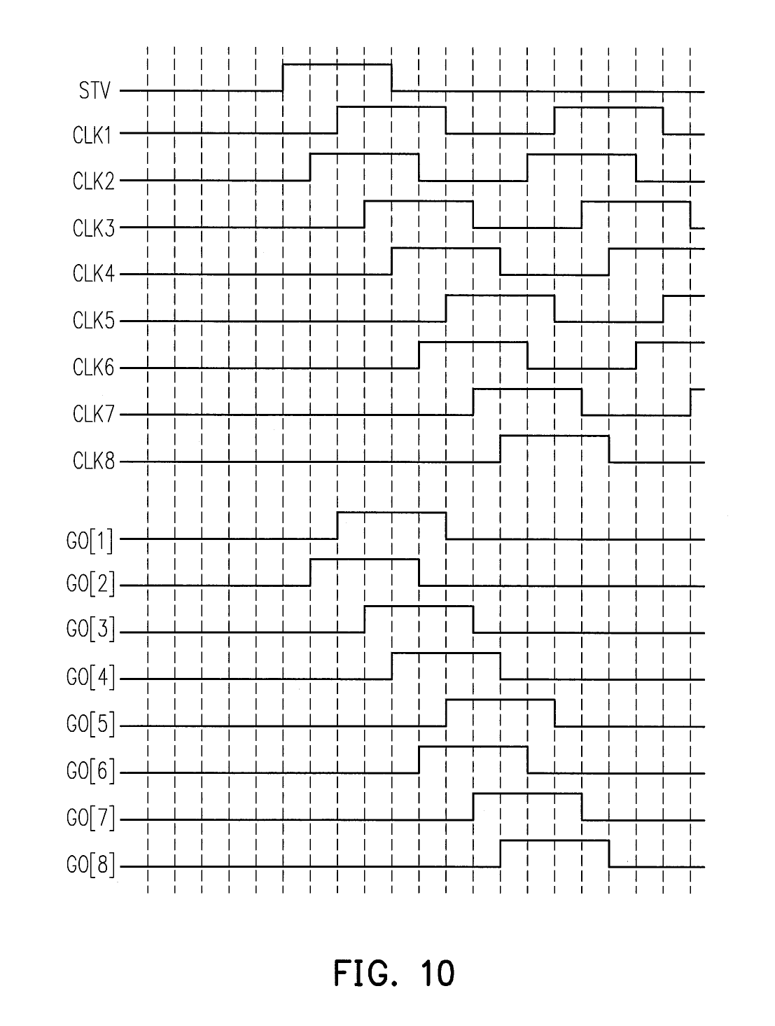

In another exemplary embodiment, the second scan sequence for turning on the gate lines may also be: GO[2]→GO[1]→GO[3]→GO[4]→GO[6]→GO[5]→GO[7]→GO[8], as shown in FIG. 10. Referring to FIG. 10, FIG. 10 defines a second C/invert-C mixed driving mode of the scan signals GO[1] to GO[8], i.e. the C and invert-C mixed mode. In the embodiment, the charging sequence for the pixels of the display panel is as shown in FIG. 3D.

Therefore, in the exemplary embodiment, based on the second scan sequence, a driving mode of the scan signals GO[1] to GO[N] may be the first C/invert-C mixed driving mode or the second C/invert-C mixed driving mode. Alternatively, in another exemplary embodiment, the second C/invert-C mixed driving mode may also serve as a third scan sequence of the scan signals GO[1] to GO[N], so as to drive the gate lines during the third or the subsequent gate output sequence.

In the exemplary embodiment, the gate driver stages 510_1 to 510_N are categorized into four gate driver groups. Therefore, by adjusting the timing at which the eight clock signals CLK1 to CLK8 are transmitted to the gate driver stages, 24 types of driving modes can be generated. Thus, the gate driver stages 510_1 to 510_N may drive the gate lines by selecting two or more types of driving modes from the 24 types of driving modes during different gate output sequences so as to improve the display quality of the panel.

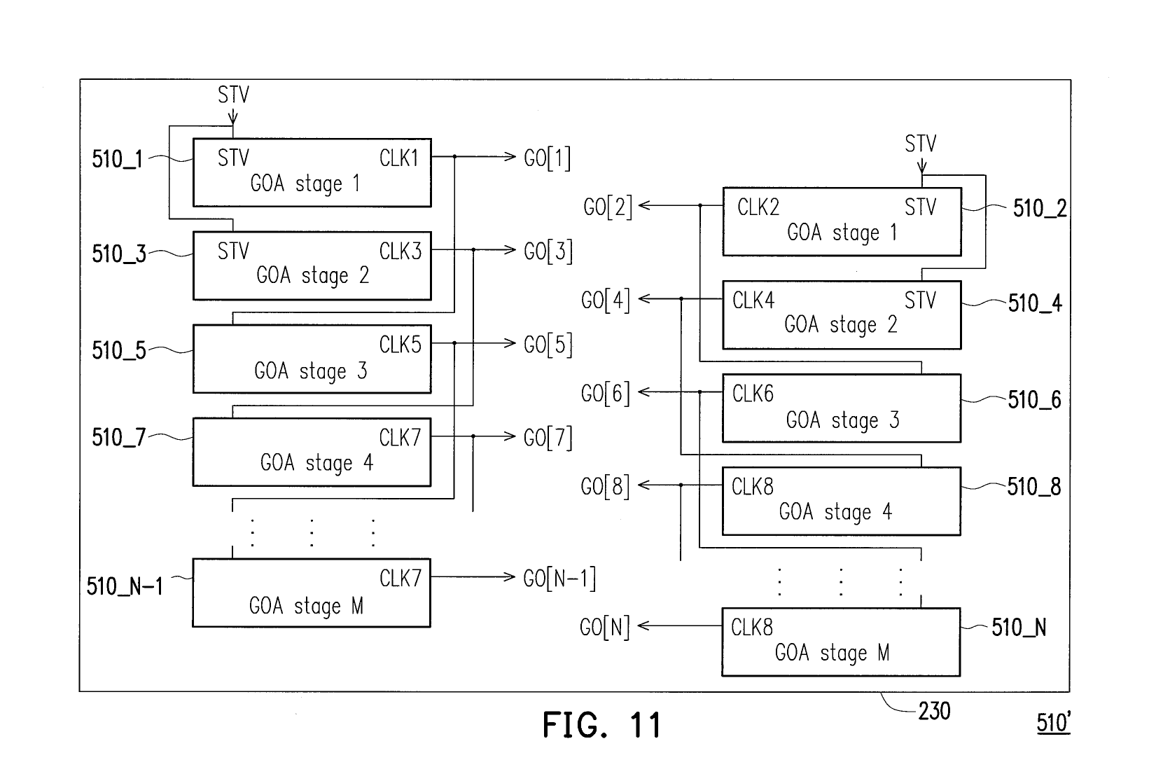

FIG. 11 is diagram illustrating an internal circuit layout of a gate driver circuit in another embodiment of the disclosure. Referring to FIGS. 7 and 11, a gate driver circuit 510′ in the exemplary embodiment is similar to the gate driver circuit 510 in FIG. 7, and the main difference between them lies in that, for example, a first and third gate driver groups in the exemplary embodiment are configured in one side of a display panel 230; a second and fourth gate driver groups are configured in another side of the display panel 230 relative to the first and third gate driver groups.

In addition, since the method for driving the gate lines in the exemplary embodiment is similar to the disclosure in FIG. 7, sufficient teaching, suggestions, and embodiments can be obtained from the description regarding the embodiments of FIGS. 8 to 10, and no further description is incorporated herein.

To sum up, in the foregoing exemplary embodiments, the scan signals drive the gate lines of the display panel in at least the first scan sequence and the second scan sequence during different frame periods. Based on the first scan sequence, the driving mode of the scan signals is one selected from the Z driving mode, the invert-Z driving mode, the first C/invert-C mixed driving mode, and the second C/invert-C mixed driving mode. Based on the second scan sequence, the driving mode of the scan signals is one which is selected from the Z driving mode, the invert-Z driving mode, the first C/invert-C mixed driving mode, and the second C/invert-C mixed driving mode and is different from a driving mode to which the first scan sequence corresponds.

In other exemplary embodiments, the scan signals may also drive the gate lines of the display panel in at least a first scan sequence, a second scan sequence, and a third scan sequence during different frame periods, wherein at least two scan sequences among the first scan sequence, second scan sequence, and third scan sequence are different, which is described specifically as follows.

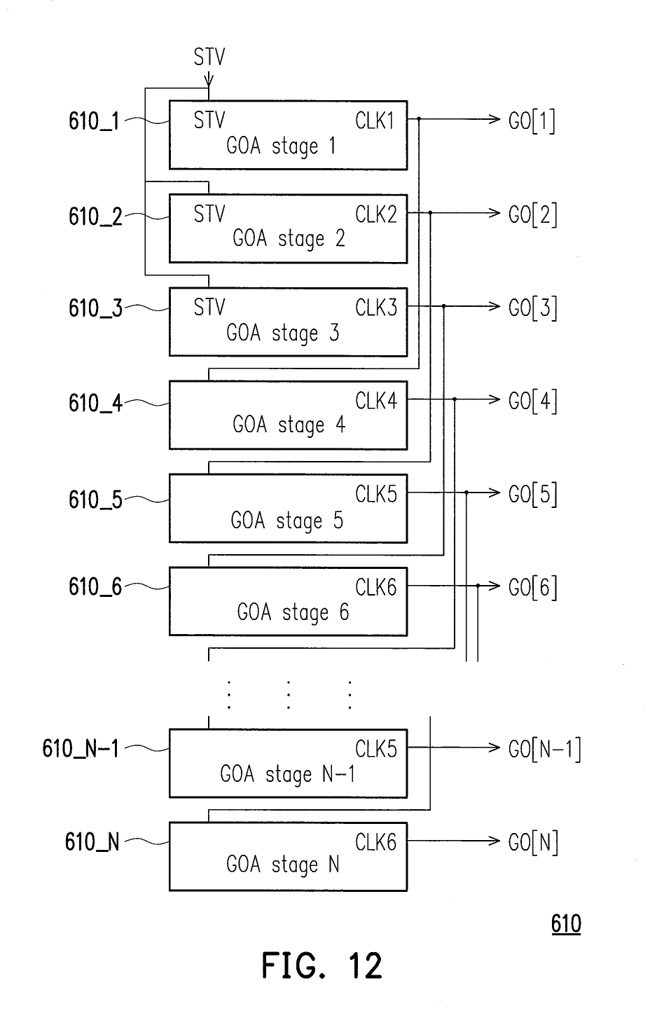

FIG. 12 is diagram illustrating an internal circuit layout of a gate driver circuit in another embodiment of the disclosure. Referring to FIGS. 4 and 12, a gate driver circuit 610 in the exemplary embodiment is similar to the gate driver circuit 410 in FIG. 4, and the main difference between them lies in that, for example, gate driver stages 610_1 to 610_N in the exemplary embodiment are categorized into three gate driver groups. A first gate driver group includes gate driver stages 610_1, 610_4, . . . , and 610_N−2 (not shown); a second gate driver group includes gate driver stages 610_2, 610_5, . . . , and 610_N−1; a third gate driver group includes gate driver stages 610_3, 610_6, . . . , and 610_N. At this time, N is a multiple of 3 and is greater than 6.

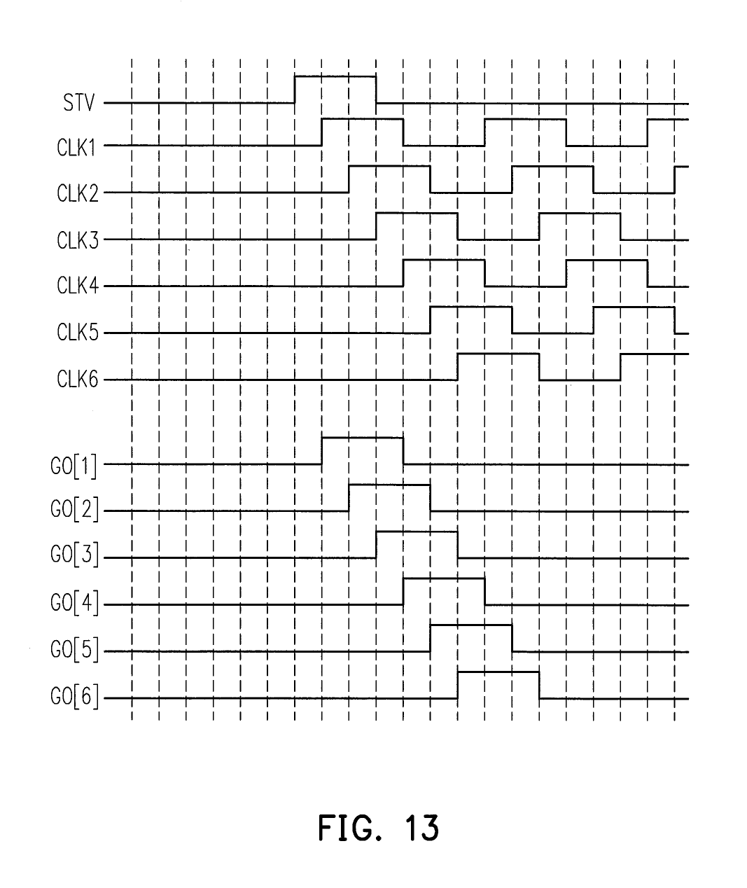

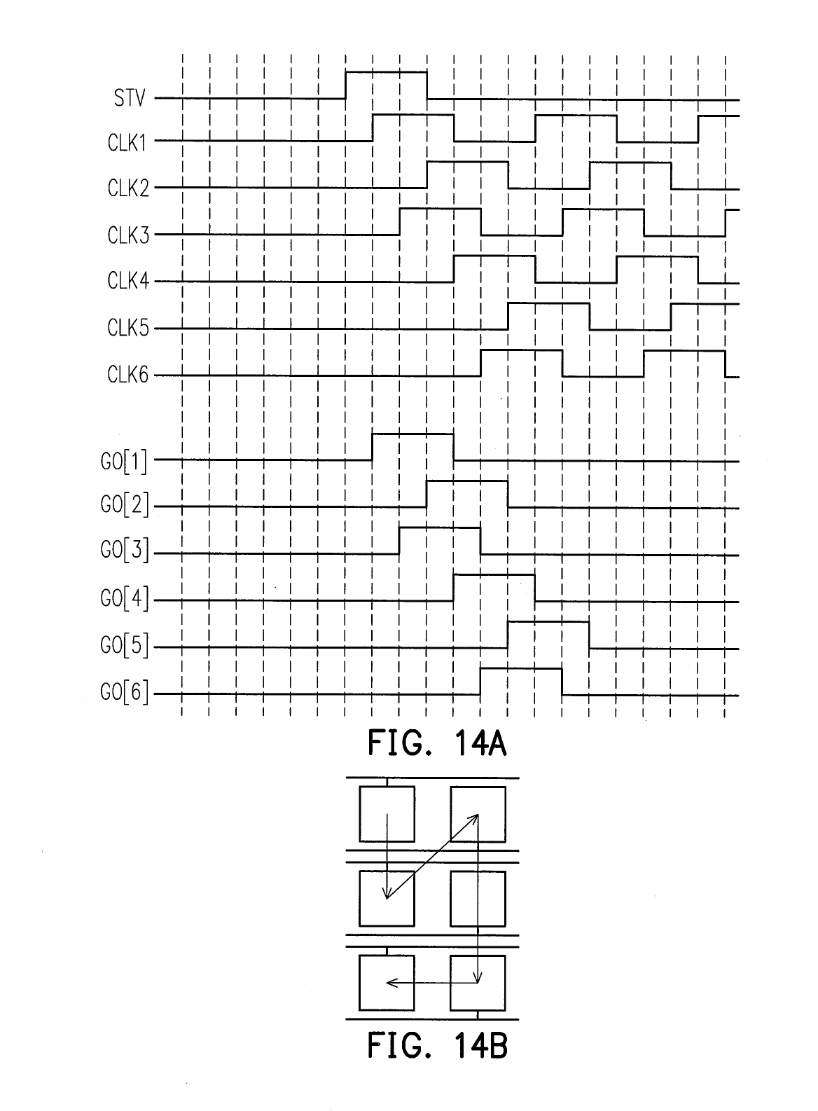

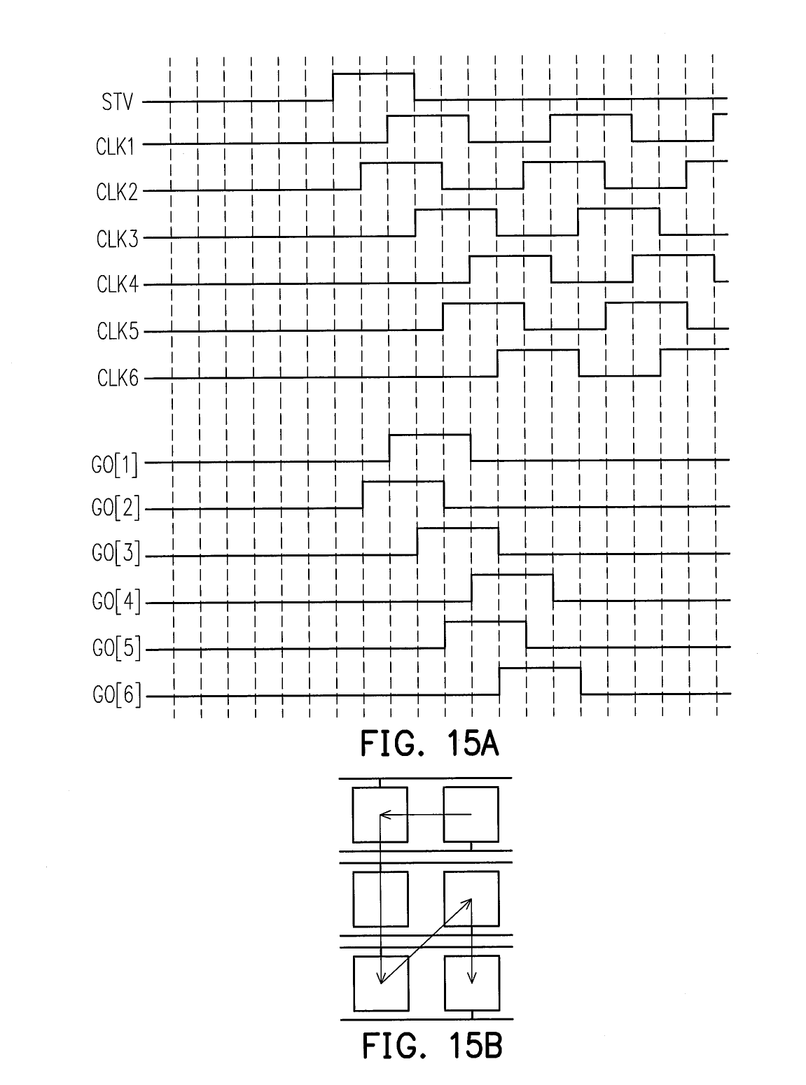

FIGS. 13, 14A, and 15A are signal waveform diagrams respectively illustrating each signal of the gate driver circuit during three consecutive gate output sequences. FIGS. 14B and 15B are diagrams respectively illustrating charging sequences for a portion of pixels of a display panel during a second and a third gate output sequences. In order to keep the description brief, in FIGS. 13, 14A, and 15A, only the signal waveform diagrams of the six gate driver stages 610_1 to 610_6 are provided as examples; however, the number of the signal waveform diagrams provides no limitation to the scope of the disclosure.

Referring to FIG. 13, the gate driver stages 610_1 to 610_6 receive clock signals CLK1 to CLK6 that are in sequence during the first gate output sequence. Therefore, based on the clock signals, the gate driver stages 610_1 to 610_6 also generate the scan signals GO[1] to GO[6] that are in sequence to drive the display panel, and the charging sequence for the pixels of the display panel is a Z pixel charging sequence as shown in FIG. 3A. Accordingly, during the first gate output sequence, the scan signals GO[1] to GO[6] turn on the gate lines in a first scan sequence: GO[1]→GO[2]→GO[3]→GO[4]→GO[5]→GO[6].

Thereafter, during the second gate output sequence, referring to FIG. 14A, FIG. 14A defines a y driving mode of the scan signals GO[1] to GO[6], and the scan signals turn on the gate lines in a second scan sequence: GO[1]→GO[3]→GO[2]→GO[4]→GO[6]→GO[5]. During the second gate output sequence, the gate driver stages 610_1 to 610_6 accomplish a y pixel charging sequence as shown in FIG. 14B based on the start pulse STV and the clock signals CLK1 to CLK6. From another perspective, comparing the clock signals CLK1 to CLK6 in FIGS. 13 and 14A, during the first gate output sequence, the clock signals CLK1 to CLK6 are sequentially transmitted to the gate driver stages 610_1 to 610_6. During the second gate output sequence, in comparison with the first gate output sequence, the sequences in which the clock signals CLK2 and CLK3 are transmitted to the gate driver stages are switched, and the sequences in which the clock signals CLK5 and CLK6 are transmitted to the gate driver stages are also switched. Therefore, the scan signals GO[1] to GO[6] generated during different gate output sequences also have the same sequence feature in corresponding to the clock signals CLK1 to CLK6.

Thereafter, during the third gate output sequence, referring to FIG. 15A, FIG. 15A defines an invert-y driving mode of the scan signals GO[1] to GO[6], and the scan signals turn on the gate lines in a third scan sequence: GO[2]→GO[1]→GO[3]→GO[5]→GO[4]→GO[6]. During the third gate output sequence, the gate driver stages 610_1 to 610_6 accomplish the invert-y pixel charging sequence as shown in FIG. 15B based on the start pulse STV and the clock signals CLK1 to CLK6. From another perspective, comparing the clock signals CLK1 to CLK6 in FIGS. 13 and 15A, during the first gate output sequence, the clock signals CLK1 to CLK6 are sequentially transmitted to the gate driver stages 610_1 to 610_6. During the third gate output sequence, in comparison with the first gate output sequence, the sequences in which the clock signals CLK1 and CLK2 are transmitted to the gate driver stages are switched, and the sequences in which the clock signals CLK4 and CLK5 are transmitted to the gate driver stages are also switched. Accordingly, the scan signals GO[1] to GO[6] generated during different gate output sequences also have the same sequence feature in corresponding to the clock signals CLK1 to CLK6.

Subsequently, in the fourth and the subsequent gate output sequences, the gate driver stages 610_1 to 610_N may drive the gate lines of the display panel in a first scan sequence, a second scan sequence, or a third scan sequence; the disclosure is not limited thereto.

In the exemplary embodiment, the gate driver stages 610_1 to 610_N are categorized into three gate driver groups. Therefore, by adjusting the timing at which the six clock signals CLK1 to CLK6 are transmitted to the gate driver stages, 6 types of driving modes can be generated. Thus, the gate driver stages 610_1 to 610_N may drive the gate lines by selecting two or more types of driving modes from the 6 types of driving modes during different gate output sequences so as to improve the display quality of the panel.

To sum up, in the foregoing exemplary embodiments, the scan signals drive the gate lines of the display panel in at least the first scan sequence, the second scan sequence, and the third scan sequence during different frame periods, wherein at least two scan sequences among the first scan sequence, the second scan sequence, and the third scan sequence are different. Based on the first scan sequence, a driving mode of the scan signals is one selected from the Z driving mode, the y driving mode, and the invert-y driving mode. Based on the second scan sequence, a driving mode of the scan signals is one which is selected from the Z driving mode, the y driving mode, and the invert-y driving mode and is different from a driving mode to which the first scan sequence corresponds. Based on the third scan sequence, a driving mode of the scan signals is one which is selected from the Z driving mode, the y driving mode, and the invert-y driving mode and is different from a driving mode to which the first scan sequence and the second scan sequence correspond.

In addition, in the exemplary embodiment, although the gate driver circuit drives the gate lines of the display panel by the scan signals in different scan sequences during the three consecutive gate out sequences, the disclosure is not limited thereto. If scan signals in different scan sequences are used to drive the gate lines of the display panel during two consecutive gate output sequences, the spirit of the present disclosure would have been well fulfilled. In the subsequent third gate output sequence, the scan sequence of the scan signals may be the same as or different from the previous two consecutive gate output sequences.

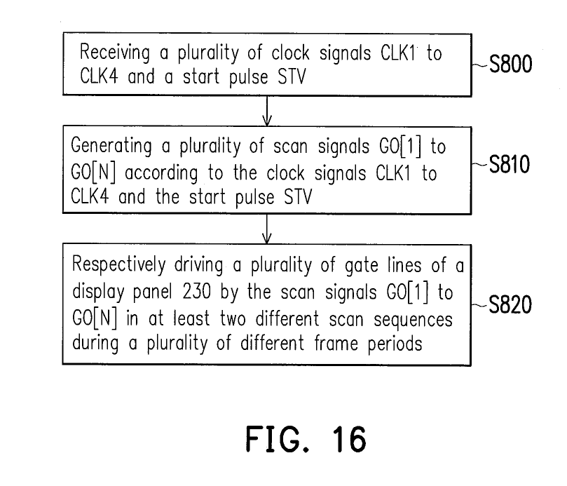

FIG. 16 is a flowchart illustrating steps in a method for driving gate lines in an embodiment of the disclosure. Referring to both FIGS. 4 and 16, the method for driving the gate lines in the exemplary embodiment includes the following steps. First of all, in step S800, a plurality of gate driver stages 410_1 to 410_N are used to receive a plurality of clock signals CLK1 to CLK4 and a start pulse STV. The gate driver stages 410_1 to 410_N are combined on a display panel 230 to form a GOA configuration. Thereafter, in step S810, the gate driver stages 410_1 to 410_N are used to generate a plurality of scan signals GO[1] to GO[N] based on the clock signals CLK1 to CLK4 and the start pulse STV. In the embodiment, during different frame periods, the scan signals GO[1] to GO[N] have different scan sequences, as shown in FIGS. 5A and 6A. Then, in step S820, the gate driver stages 410_1 to 410_N are used to respectively drive a plurality of gate lines of the display panel 230 by the scan signals GO[1] to GO[N] during different frame periods, wherein at least two scan sequences among the scan sequences are different.

Additionally, sufficient teaching, suggestions, and embodiments with regard to the method for driving the gate lines in the embodiments of the disclosure can be obtained from FIGS. 1 to 15B, and therefore no further description is incorporated herein.

In summary, in the exemplary embodiments of the disclosure, the gate driver circuit configured on the display panel generates two or more types of scan signals that are not arranged in sequence by receiving clock signals in different timing, thereby accomplishing a space-averaged effect. The quality of the display image can be improved through time- or space-averaging.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. A gate driver circuit, comprising:
a plurality of gate driver stages, combined on a display panel for receiving a plurality of clock signals and a start pulse, and after being started by the start pulse, the gate driver stages generating a plurality of scan signals based on the clock signals,
wherein the scan signals drive a plurality of gate lines of the display panel in a plurality of scan sequences during different frame periods based on the clock signals, wherein at least two scan sequences among the scan sequences are different.

2. The gate driver circuit according to claim 1, wherein the scan signals drive the gate lines of the display panel in at least a first scan sequence and a second scan sequence during the different frame periods, wherein the first scan sequence and the second scan sequence are different.

3. The gate driver circuit according to claim 2, wherein based on the first scan sequence, a driving mode of the scan signals is one selected from a Z driving mode, an invert-Z driving mode, a first C/invert-C mixed driving mode, and a second C/invert-C mixed driving mode.

4. The gate driver circuit according to claim 3, wherein based on the second scan sequence, a driving mode of the scan signals is one selected from the Z driving mode, the invert-Z driving mode, the first C/invert-C mixed driving mode, and the second C/invert-C mixed driving mode and is different from the driving mode to which the first scan sequence corresponds.

5. The gate driver circuit according to claim 1, wherein the scan signals drive the gate lines of the display panel in at least a first scan sequence, a second scan sequence, and a third scan sequence during the different frame periods, wherein at least two scan sequences among the first scan sequence, the second scan sequence, and the third scan sequence are different.

6. The gate driver circuit according to claim 5, wherein based on the first scan sequence, a driving mode of the scan signals is one selected from a Z driving mode, a y driving mode, and an invert-y driving mode.

7. The gate driver circuit according to claim 6, wherein based on the second scan sequence, a driving mode of the scan signals is one selected from the Z driving mode, the y driving mode, and the invert-y driving mode and is different from the driving mode to which the first scan sequence corresponds.

8. The gate driver circuit according to claim 7, wherein based on the third scan sequence, a driving mode of the scan signals is one selected from the Z driving mode, the y driving mode, and the invert-y driving mode and is different from the driving modes to which the first scan sequence and the second scan sequence correspond.

9. The gate driver circuit according to claim 1, wherein the gate driver stages are categorized into a plurality of gate driver groups, and each of the gate driver groups comprises a first gate driver stage and a plurality of second gate driver stages, and after being started by the start pulse, the first gate driver stage generates a corresponding scan signal of the scan signals based on one of the clock signals, and each of the second gate driver stages generates a corresponding scan signal of the scan signals based on the clock signals and an output of a gate driver stage prior to the each of the second gate driver stages.

10. The gate driver circuit according to claim 9, wherein the gate driver stages are categorized into X of gate driver groups, the clock signals comprise Y of clock signals, wherein Y=2X, X≧2, and X, Y are natural numbers.

11. A method for driving gate lines of a display panel, comprising:
receiving a plurality of clock signals and a start pulse by a plurality of gate driver stages, wherein the gate driver stages are combined on the display panel;
generating a plurality of scan signals based on the clock signals and the start pulse the gate driver stages, wherein the scan signals have a plurality of scan sequences during different frame periods; and
respectively driving a plurality of gate lines of the display panel by the scan signals during the different frame periods by the gate driver stages, wherein at least two scan sequences of the scan sequences are different.

12. The method for driving the gate lines according to claim 11, wherein in the step of respectively driving the gate lines of the display panel during the different frame periods by the scan signals, the gate lines are driven in at least a first scan sequence and a second scan sequence, wherein the first scan sequence and the second scan sequence are different.

13. The method for driving the gate lines according to claim 12, wherein based on the first scan sequence, a driving mode of the scan signals is one selected from a Z driving mode, an invert-Z driving mode, a first C/invert-C mixed driving mode, and a second C/invert-C mixed driving mode.

14. The method for driving the gate lines according to claim 13, wherein based on the second scan sequence, a driving mode of the scan signals is one selected from the Z driving mode, the invert-Z driving mode, the first C/invert-C mixed driving mode, and the second C/invert-C mixed driving mode and is different from the driving mode to which the first scan sequence corresponds.

15. The method for driving the gate lines according to claim 11, wherein in the step of driving the gate lines of the display panel during the different frame periods by the scan signals to, the gate lines of the display panel are driven in at least a first scan sequence, a second scan sequence, and a third scan sequence, wherein at least two scan sequences of the first scan sequence, the second scan sequence, and the third scan sequence are different.

16. The method for driving the gate lines according to claim 15, wherein based on the first scan sequence, a driving mode of the scan signals is one selected from a Z driving mode, a y driving mode, and an invert-y driving mode.

17. The method for driving the gate lines according to claim 16, wherein based on the second scan sequence, a driving mode of the scan signals is one selected from the Z driving mode, the y driving mode, and the invert-y driving mode and is different from the driving mode to which the first scan sequence corresponds.

18. The method for driving the gate lines according to claim 17, wherein based on the third scan sequence, a driving mode of the scan signals is one selected from the Z driving mode, the y driving mode, and the invert-y driving mode and is different from the driving modes to which the first scan sequence and the second scan sequence correspond.
